(19) United States
(12) Patent Application Publication
(10) Pub. No.: US 2025/0382186 A1
(43) Pub. Date: Dec. 18, 2025

(54) SILANE RECOVERY DEVICE AND METHOD

(71) Applicant: SK INC., Seoul (KR)

(72) Inventors: Deok Ho LEE, Seoul (KR); Soon Pyo LEE, Seoul (KR); Bohyun SEONG, Seoul (KR); Geun CHOI, Seoul (KR)

(21) Appl. No.: 18/876,031

(22) PCT Filed: Jun. 12, 2023
(86) PCT No.: PCT/KR2023/008068

§ 371 Date: Dec. 17, 2024

(30) Foreign Application Priority Data
Jun. 17, 2022 (KR) 10-2022-0074396

(51) Int. Cl. C01B 33/04

(52) U.S. Cl. CPC C01B 33/043; C01B 33/046

(57) ABSTRACT

The present invention relates to a silane recovery device and method and, more specifically, is to provide a silane recovery device and method, which enable the recovery and recycling of silane by efficiently removing impurities such as hydrogen, nitrogen, etc., from silane gas, which is an unreacted by-product generated from processes using silane as a raw material in the fields of silane manufacturing facilities or semiconductors, displays, batteries, etc.

### TECHNICAL FIELD

The present invention relates to a silane recovery device and method, and more specifically, to a silane recovery device and method, which efficiently recovers and recycles silane gas, which is an unreacted by-product generated from a silane manufacturing facility or a process that uses silane as a raw material in the fields of semiconductors, displays, batteries, and the like.

### BACKGROUND ART

Silane is an important raw material for obtaining silicon used in lithium secondary batteries, semiconductors, and photovoltaic industries. In manufacturing negative electrode materials for a secondary battery, the purity of silicon, which is a raw material, is a critical factor that determines the electrical characteristics of the product or the like, and thus the purity of the gaseous precursor (silane), which is a raw material for silicon, is very important.

Silane generated in the process of manufacturing the negative electrode materials for a lithium secondary battery may contain, in addition to volatile solvents, lightweight impurities, such as hydrogen and nitrogen, that can be distilled at low boiling points.

U.S. Pat. No. 5,211,931 discloses a purification method comprising: (1) passing silane gas containing lighter impurities, heavier impurities, and ethylene through a first distillation column to remove the lighter impurities, (2) removing the heavier impurities from the silane gas with the lighter impurities removed, (3) passing the silane gas with the heavier impurities removed through a molecular sieve and converting ethylene into ethyl silane, and (3) passing the silane gas containing the ethyl silane through a distillation column and reducing a concentration of the ethyl silane. The above technology describes that ultimately, purified silane having a content of ethyl silane reduced to less than 0.01 ppm can be obtained.

Japanese Patent No. 5686527 discloses a method of recovering residual gas, which includes continuously supplying mixed gas remaining in a cylinder to a separator module having a gas separator with molecular sieve action, separating the mixed gas into gas components having small molecular diameters and gas components having large molecular diameters, and then recovering gas components with a small molecular diameter and gas components with a large molecular diameter.

Korean Patent No. 1136417 discloses a method of purifying silane, which can obtain an ultra-high purity target compound from which impurities, particularly, impurities such as ethylene, ethyl silane, etc. are completely removed. In addition, the method discloses that it is possible to provide a purification method that is excellent in energy efficiency because it does not require a separate process such as regeneration of an adsorbent, can be stably and continuously performed even under mild conditions of a low pressure, and does not have a negative effect on the quality of the final purified silane even when there is a deviation in process conditions.

Korean Laid-Open Patent No. 2013-0053720 discloses a silane recovery device for recovering silane gas, which is a byproduct generated during a process of manufacturing polysilicon, in a liquid state, which includes a housing, a gas inlet provided on a lower portion of the housing, a primary cyclone droplet unit installed on the lower portion inside the housing to convert silane gas introduced through the gas inlet into droplets, a cooling space installed on an upper portion of the primary cyclone droplet unit to reduce a temperature of silane gas passing through the primary cyclone droplet unit by a cooling unit, a secondary droplet unit installed on an upper portion of the cooling space unit to convert silane gas passing through the cooling space into droplets, a filtration filter mounted vertically at a predetermined interval on an upper portion of the secondary droplet unit to filter and coagulate fine silane droplets passing through the secondary droplet unit, a gas discharge unit installed on an upper portion of the housing to pass through the filtration filter and discharge gas with silane removed, and a silane liquid collector provided on a lower portion inside the primary cyclone droplet unit to collect a silane liquid condensed and recovered from the first cyclone droplet unit, the cooling space, the second droplet unit, and the filtration filter.

### DISCLOSURE

(Patent Document 1) Korean Laid-Open Patent No. 10-2013-0053720

### Technical Problem

The present invention relates to a silane recovery device and method, and more specifically, provides a silane recovery device and method, which efficiently recovers and recycles silane gas, which is an unreacted by-product generated from a silane manufacturing facility or a process that uses silane as a raw material in the fields of semiconductors, displays, batteries, and the like.

### Technical Solution

A silane recovery method according to the present invention preferably includes operation (a) of cooling and pressing a supply mixed fluid, operation (b) of cooling the cooled and pressed supply mixed fluid to recover liquid silane separated from gaseous waste gas, operation (c) of discharging the gaseous waste gas to a waste gas treatment unit 12, and operation (d) of evaporating the liquid silane and transferring the liquid silane to a silane storage unit 11.

A combination of operation (b) and operation (c) is preferably performed parallel to a combination of another operation (b) and another operation (c).

The silane recovery method preferably further includes an operation of recirculating a part of the gaseous waste gas of operation (c) to a front end of operation (b).

The silane recovery method preferably further includes an operation of recirculating the supplied mixed fluid from a rear end of operation (a) to a front end of operation (a) when a conversion rate is 0% in a process before the silane recovery process.

The silane recovery method preferably further includes an operation of discharging the supplied mixed fluid to an emergency discharge unit without treatment in one or more of operations (b) to (d) when an emergency situation occurs.

The silane recovery method preferably further includes an operation of cooling the supplied mixed fluid supplied from the emergency discharge unit and liquefying silane.

The silane recovery method preferably further includes an operation of gradually evaporating the liquefied silane and discharging the evaporated silane to a waste gas treatment unit when the emergency situation is released.

As another specific example of the present invention, the silane recovery device of the present invention preferably includes a pretreatment unit configured to cool and press a supplied mixed fluid, a silane treatment unit configured to cool and separate a gas-liquid from the cooled and pressed supplied mixed fluid, a waste gas treatment unit configured to discharge the gas-liquid separated gaseous waste gas; an evaporator configured to evaporate the gas-liquid separated liquid silane, and a silane storage unit configured to store the evaporated silane.

The pretreatment unit preferably includes one or more of a strainer, a first cooler, a second cooler, a buffer tank, a blower, and an economizer.

The silane treatment units are preferably provided in parallel.

The silane treatment device preferably includes a silane upper condenser, a silane recovery unit, and a liquid nitrogen supply unit.

The silane treatment device preferably further includes a recirculation unit configured to recirculate a part of the gas-liquid separated gaseous waste gas to a front end of the pretreatment unit.

When the conversion rate is 0% during the negative electrode material manufacturing process prior to the silane recovery process, the silane treatment device preferably further includes a recirculation unit configured to recirculate the supplied mixed fluid from the rear end of the pretreatment unit to the front end of the pretreatment unit.

In the event of an emergency, the silane treatment device preferably further includes an emergency discharge unit configured to discharge the supplied mixed fluid from the silane treatment unit, a front end of the silane storage unit, or both of them without treatment.

The silane treatment device preferably further includes a silane treatment unit and a waste gas treatment unit in fluid communication with the emergency discharge unit.

The silane treatment unit preferably includes an emergency condenser, an emergency silane recovery unit, and a liquid nitrogen supply unit.

### Advantageous Effects

The present invention relates to a silane recovery device and method and, more specifically, provides a silane recovery device and method, which enable the recovery and recycling of silane by efficiently removing impurities such as hydrogen, nitrogen, etc., from silane gas, which is an unreacted by-product generated from processes using silane as a raw material in the fields of silane manufacturing facilities or semiconductors, displays, batteries, etc.

### DESCRIPTION OF DRAWINGS

FIG. 1 schematically illustrates a silane recovery device according to the present invention.

FIG. 2 schematically illustrates a device driven in an emergence situation in the silane recovery device according to the present invention.

### MODE FOR INVENTION

A silane recovery method according to the present invention preferably includes operation (a) of cooling and pressing a supplied mixed fluid, operation (b) of cooling the cooled and pressed suppled mixed fluid to recover liquid silane separated from gaseous waste gas, operation (c) of discharging the gaseous waste gas to a waste gas treatment unit 12, and operation (d) of evaporating the liquid silane and transferring the liquid silane to a silane storage unit 11.

Hereinafter, embodiments of the present invention will be described in detail so that those skilled in the art can easily carry out the present invention. The embodiments of the present invention are provided to more completely describe the present invention to those skilled in the art. However, the embodiments of the present invention may be modified into various other forms, and the scope of the present invention is not limited to embodiments described below.

Throughout the specification of the present invention, when a certain portion is described as “including” a certain component, it means that the certain portion further includes another component rather than precluding another component unless specifically stated to the contrary.

Throughout the specification of the present invention, when a certain operation is described as being positioned “on” or “before” another operation, this may include the same scope as a case in which the certain operation has a direct chronological relationship with another operation and in a case in which the order of the two operations has an indirect chronological relationship in which a chronological order can be changed, such as a mixing operation after each operation.

Terms “about,” “substantially,” or the like used throughout the specification are used to mean a numerical value or the approximation of the numerical value when unique manufacturing and material tolerances are presented to stated meaning and are used to prevent infringers from unfairly using the disclosed content in which accurate or absolute values are mentioned to help the understanding of the present invention. Terms “operation of ˜ (ing)” or “operation of” used throughout the specification of the present invention do not mean “operation for.”

A negative electrode material manufacturing process prior to the silane recovery process according to the present invention is a process of manufacturing a silicon negative electrode material and is a process of manufacturing a silicon negative electrode material by mixing silicon with solid carbon.

Hereinafter, the silane recovery method and device according to the present invention will be exemplarily described with reference to the drawings.

The silane recovery method according to the present invention is directed to recovering unreacted silane (SiH4). Design criteria of the silane recovery method according to the present invention are flexibly applied to a conversion rate of the previous negative electrode material manufacturing process.

The supplied mixed fluid flowing into the silane recovery method of the present invention from the previous negative electrode material manufacturing process includes byproducts (hydrogen, etc.) and a carrier (nitrogen carrier gas) in addition to unreacted silane. The silane recovery method of the present invention cools the supplied mixed fluid to −168° C. to recover silane with high purity and burns the remainder.

However, at an initial start-up time point when reaction does not proceed, a case in which the conversion rate is 0% may occur, and such a situation is considered in the design. When the conversion rate is 0%, the supplied mixed fluid contains only silane and nitrogen. In this case, silane may be additionally liquefied more than the design allowance of a silane recovering operation, and nitrogen may actually have a small flow amount, and thus actual waste gas may be produced in a very small amount. Accordingly, to secure unnecessary process operation and safety, the supplied mixed fluid may be recycled from a rear end of a blower 5 to a front end of a strainer 1.

The silane recovery method according to the present invention preferably includes operation (a) of cooling and pressing a supplied mixed fluid, operation (b) of cooling the cooled and pressed supplied mixed fluid to recover liquid silane separated from gaseous waste gas, operation (c) of discharging the gaseous waste gas to the waste gas treatment unit 12, and operation (d) of evaporating the liquid silane and transferring the liquid silane to the silane storage unit 11.

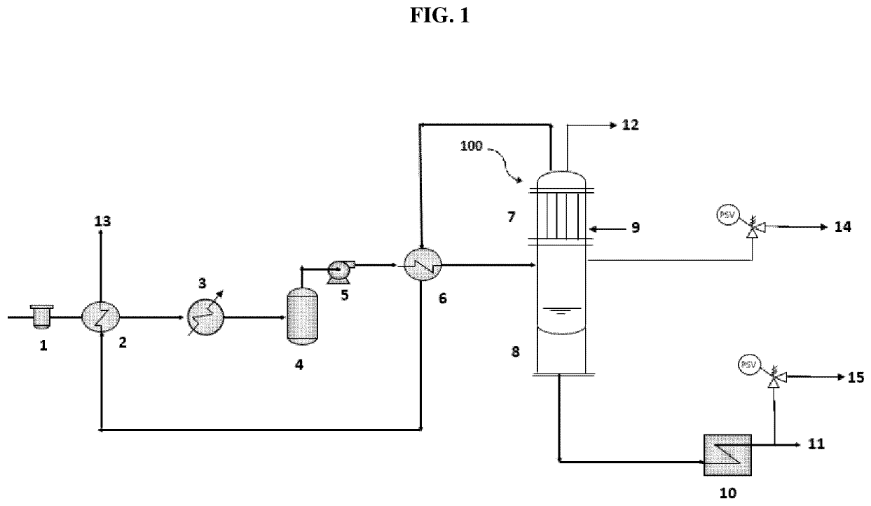

Describing in more detail with reference to FIG. 1, operation (a) of cooling and pressing the supplied mixed fluid containing nitrogen as a carrier gas is performed by transferring the supplied mixed fluid in the order of the strainer 1, a first cooler 2, a second cooler 3, a buffer tank 4, a blower 5, and an economizer 6.

Specifically, the strainer 1 is a device for removing solids contained in the fluid to prevent foreign substances from flowing into subsequent devices and the like and is not limited to a specific form within a range that is obvious to those skilled in the art as long as it has the same function and effect.

The first cooler 2 is a device for cooling a temperature of the supplied mixed fluid introduced from the previous negative electrode material manufacturing process from about 400 to 450° C. to about 200 to 280° C. An external cooling device may be used, but is not limited to a specific form within a range that is obvious to those skilled in the art as long as it has the same function and effect. In the present invention, it is preferable to recirculate and cool the gaseous waste gas of operation (c).

The second cooler 3 is a device for cooling the supplied mixed fluid discharged from the first cooler 2 from about 200 to 280° C. to about 0 to 40° C. The maximum temperature of 40° C. is to consider an operating temperature of the subsequent blower 5. Cooling water may be used for cooling and is not limited to a specific form within a range that is obvious to those skilled in the art as long as it has the same function and effect.

The buffer tank 4 is a device for maintaining the constant pressure of the cooled supplied mixed fluid and maintaining a pressure of the fluid supplied to the subsequent blower 5 as constant as possible and is not limited to a specific form within a range that is obvious to those skilled in the art as long as it has the same function and effect.

The blower 5 discharges the supplied mixed fluid supplied in a state of about −20to 10 mbarg and about 0 to 40° C. in a state of about 0.5 barg and about 100 to 130° C. A discharged state of the supplied mixed fluid discharged from the blower 5 may be set considering the subsequent silane treatment unit 100 or the waste gas treatment unit 13. Since silane of the supplied mixed fluid is a toxic gas, the root type is preferred, and since the silane contains hydrogen, an explosion-proof device is preferably provided. The blower is not limited to a specific form within a range that is obvious to those skilled in the art as long as it has the same function and effect.

The economizer 6 is a device for cooling the supplied mixed fluid discharged from the blower 5 with a temperature of about 100 to 130° C. to −20 to 0° C. An external cooling device may be used, but is not limited to a specific form within a range that is obvious to those skilled in the art as long as it has the same function and effect. In the present invention, it is preferable to recirculate and cool the gaseous waste gas of operation (c).

Operation (b) of cooling the cooled and pressed supplied mixed fluid and recovering the liquid silane separated from the gaseous waste gas is performed in the silane treatment unit 100. The silane treatment unit includes a silane upper condensation unit 7, a silane recovery unit 8, and a liquid nitrogen supply unit 9.

The silane upper condensation unit 7 cools the temperature of the supplied mixed fluid supplied from the economizer 6 to about −20° C. using the liquid nitrogen supplied through the liquid nitrogen supply unit 9, separates the condensed silane from the uncondensed gaseous waste gas, and collects the silane in the silane recovery unit 8. In the present invention, a silane recovery rate from the supplied mixed fluid is 94.4%, which is very excellent.

The liquid nitrogen supplied to the liquid nitrogen supply unit 9 is in a state of about −174° C. and cools the supplied mixed fluid using its latent heat.

Since the silane recovery unit 8 is in the form of a jacket, can prevent silane from re-vaporizing due to an atmospheric temperature, and maintains the constant temperature using the liquid nitrogen supplied from the liquid nitrogen supply unit 9. The silane recovery unit 8 is not limited to a specific form within a range that is obvious to those skilled in the art as long as it has the same function and effect.

The silane treatment unit 100 may be provided in parallel as two or more silane treatment unit, and when the silane recovery unit 8 of one silane treatment unit reaches a predetermined level or higher, another silane treatment unit may be operated.

Operation (d) of evaporating the liquid silane and transferring the evaporated liquid silane to the silane storage unit 11 transfers the liquid silane recovered by the silane recovery unit 8 of the silane treatment unit 100 to the silane storage unit 11 via the subsequent evaporator 10.

The evaporator 10 heats the liquid silane transferred from the silane recovery unit 8 from about −168° C. to about 25° C. Water, steam, or a mixture thereof may be used as a heat source for evaporating the liquid silane. The silane vaporized in the evaporator may be stored in the silane storage unit 11 or supplied to the previous negative electrode material manufacturing process.

Preferably, the present invention may further include operation (e) of recirculating a part of the gaseous waste gas of operation (c), thermally exchanging the part with the economizer 6 and the first cooler 2, and then discharging the thermally exchanged part to the waste gas treatment unit 13.

The waste gas discharged from the waste gas treatment units 12 and 13 of operations (c) and (e) may be treated in typical facilities that treat air pollutants.

Preferably, the silane recovery method according to the present invention may further include operation (f) of recirculating the supplied mixed fluid from a rear end of the blower 5 to a front end of the strainer 1 when the conversion rate of the previous negative electrode material manufacturing process is 0%.

Preferably, the silane recovery method according to the present invention further includes operation (h) of discharging the supplied mixed fluid from the silane treatment units 100 and 200 to emergency discharge units 14 and 15 without any special treatment in an emergency situation such as when a fire occurs or when waste gas exceeding the treatment capacity of the waste gas treatment units 12 and 13 is generated.

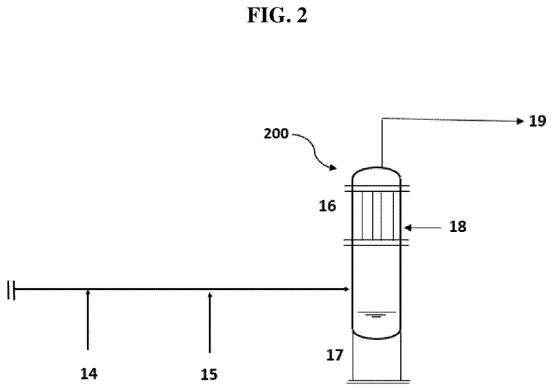

As illustrated in FIG. 2, the supplied mixed fluid discharged from the emergency discharge unit is supplied to the subsequent silane treatment unit 200. An emergency condenser 16 of the silane treatment unit cools the supplied mixed fluid from about 25° C. to about −107° C. using the liquid nitrogen supplied from the liquid nitrogen supply unit 18. Silane is condensed by cooling, and the condensed liquid silane is collected in an emergency silane recovery unit 17.

When the emergency situation is released, the liquid nitrogen is adjusted to gradually vaporize the liquid silane and discharge the vaporized silane to the waste gas treatment unit 19. The waste gas including silane discharged from the waste gas treatment unit 19 may be recirculated or treated in typical facilities for treating air pollutants.

As illustrated in FIGS. 1 and 2, as another specific example of the present invention, the silane recovery device of the present invention preferably includes a pretreatment unit for cooling and pressing a supplied mixed fluid, a silane treatment unit for cooling and separating a gas-liquid from the cooled and pressed supplied mixed fluid, a waste gas treatment unit for discharging the gas-liquid separated gaseous waste gas, an evaporator for evaporating the gas-liquid separated liquid silane, and a silane storage unit for storing the evaporated silane.

The pretreatment unit preferably includes one or more of a strainer, a first cooler, a second cooler, a buffer tank, a blower, and an economizer.

The silane treatment units are preferably provided in parallel. Two or more silane treatment units are preferably operated in parallel, and the number of silane treatment units is not limited to two within the scope of those skilled in the art.

The silane treatment unit preferably includes a silane upper condenser, a silane recovery unit, and a liquid nitrogen supply unit.

The silane treatment device preferably further includes a recirculation unit for recirculating a part of the gas-liquid separated gaseous waste gas to a front end of the pretreatment unit.

When the conversion rate is 0% during the negative electrode material manufacturing process prior to the silane recovery process, the silane treatment device preferably further includes a recirculation unit for recirculating the supplied mixed fluid from the rear end of the pretreatment unit to the front end of the pretreatment unit.

In the event of an emergency, the silane treatment device preferably further includes an emergency discharge unit for discharging the supplied mixed fluid from the silane treatment unit, the front end of the silane storage unit, or both of them without any treatment.

The silane treatment device preferably further includes a silane treatment unit and a waste gas treatment unit in fluid communication with the emergency discharge unit.

The silane treatment unit preferably includes an emergency condenser, an emergency silane recovery unit, and a liquid nitrogen supply unit.

Although the embodiments of the present invention have been described above in detail, the scope of the present invention is not limited thereto, and it will be apparent to those skilled in the art that various modifications and variations are possible without departing from the technical spirit of the present invention described in the claims.

### DESCRIPTION OF REFERENCE NUMERALS

1: strainer 2: first cooler
3: second cooler 4: buffer tank
5: blower 6: economizer
7: silane overhead condensation unit 8: silane recovery unit
9, 18: liquid nitrogen supply units 10: evaporator
11: silane storage unit 12, 13, 19: waste gas treatment units
14, 15: emergency discharge units 16: emergency condenser
17: emergency silane recovery unit 100, 200: silane treatment units

### INDUSTRIAL APPLICABILITY

The present invention relates to a silane recovery device and method and, more specifically, to a silane recovery device and method, which enable the recovery and recycling of silane by efficiently removing impurities such as hydrogen, nitrogen, etc., from silane gas, which is an unreacted by-product generated from processes using silane as a raw material in the fields of silane manufacturing facilities or semiconductors, displays, batteries, etc.

1. A silane recovery method comprising: operation (a) of cooling and pressing a supply mixed fluid; operation (b) of cooling the cooled and pressed supply mixed fluid to recover liquid silane separated from gaseous waste gas; operation (c) of discharging the gaseous waste gas to a waste gas treatment unit (12); and operation (d) of evaporating the liquid silane and transferring the liquid silane to a silane storage unit (11).

2. The silane recovery method of claim 1, wherein a combination of operation (b) and operation (c) is performed parallel to a combination of another operation (b) and another operation (c).

3. The silane recovery method of claim 1, further comprising an operation of recirculating a part of the gaseous waste gas of operation (c) to a front end of operation (b).

4. The silane recovery method of claim 1, further comprising an operation of recirculating the supplied mixed fluid from a rear end of operation (a) to a front end of operation (a) when a conversion rate is 0% in a process before the silane recovery process.

5. The silane recovery method of claim 1, further comprising an operation of discharging the supplied mixed fluid to an emergency discharge unit without treatment in one or more of operations (b) to (d) when an emergency situation occurs.

6. The silane recovery method of claim 5, further comprising an operation of cooling the supplied mixed fluid supplied from the emergency discharge unit and liquefying silane.

7. The silane recovery method of claim 6, further comprising an operation of gradually evaporating the liquefied silane and discharging the evaporated silane to a waste gas treatment unit when the emergency situation is released.

8. A silane recovery device comprising: a pretreatment unit configured to cool and press a supplied mixed fluid; a silane treatment unit configured to cool and separate a gas-liquid from the cooled and pressed supplied mixed fluid; a waste gas treatment unit configured to discharge the gas-liquid separated gaseous waste gas; an evaporator configured to evaporate the gas-liquid separated liquid silane; and a silane storage unit configured to store the evaporated silane.

9. The silane recovery device of claim 8, wherein the pretreatment unit includes one or more of a strainer, a first cooler, a second cooler, a buffer tank, a blower, and an economizer.

10. The silane recovery device of claim 8, wherein the silane treatment units are provided in parallel.

11. The silane recovery device of claim 8, wherein the silane treatment unit includes a silane upper condensation unit, a silane recovery unit, and a liquid nitrogen supply unit.

12. The silane recovery device of claim 8, further comprising a recirculation unit configured to recirculate a part of the gas-liquid separated gaseous waste gas to a front end of the pretreatment unit.

13. The silane recovery device of claim 8, further comprising a recirculation unit configured to recirculate the supplied mixed fluid from a rear end of the pretreatment unit to a front end of the pretreatment unit when a conversion rate is 0% in a process before a silane recovery process.

14. The silane recovery device of claim 8, further comprising an emergency discharge unit configured to discharge the supplied mixed fluid from the silane treatment unit, a front end of the silane storage unit, or both of them without treatment.

15. The silane recovery device of claim 14, further comprising a silane treatment unit and a waste gas treatment unit in fluid communication with the emergency discharge unit.

16. The silane recovery device of claim 15, wherein the silane treatment unit includes an emergency condenser, an emergency silane recovery unit, and a liquid nitrogen supply unit.
